(19) United States
(12) Patent Application Publication
(10) Pub. No.: US 2015/0174883 A1
(43) Pub. Date: Jun. 25, 2015

(54) LASER WELDING STRUCTURE FOR CONNECTING WATER PASSAGE ELEMENT

(71) Applicant: Xiamen Runner Industrial Corporation, Xiamen (CN)

(72) Inventor: Min Han, Xiamen (CN)

(73) Assignee: Xiamen Runner Industrial Corporation, Xiamen (CN)

(21) Appl. No.: 14/262,698

(22) Filed: Apr. 25, 2014

(30) Foreign Application Priority Data
Dec. 21, 2013 (CN) 201310709557.8

(51) Int. Cl. B32B 37/14; B32B 37/06; B32B 37/04; B32B 37/00

(52) U.S. Cl. CPC B32B 37/144; B32B 37/0046; B32B 37/06; B32B 37/04; B32B 2309/105; B32B 2310/0843; B32B 2367/00; B32B 2597/00

(57) ABSTRACT

A laser welding structure for connecting a water passage element, including: a water passage soft tube; and a soft tube connector, wrapped around one end of said water passage soft tube. Inner surfaces of said soft tube connector and said water passage soft tube are each provided with a deep-color light absorption portion, outer perimeter of said soft tube connector is a laser transmission portion, such that connection portion of said soft tube connector and said water passage soft tube is performed laser fusion, welding, and connection under irradiation of laser lights. Also disclosed is a laser welding method, to realize connection of water passage element made of plastic such as PERT, and other water passage components. As such, it can solve a problem of the prior art of inferior welding strength, large deformation, poor tight seal connection.

### BACKGROUND OF THE INVENTION

1. Field of the Invention

The present invention relates to a laser welding structure for connecting water passage element, and in particular to a laser welding structure for connecting water passage element, such as shower spray head in a bath room; faucet in a kitchen/bathroom; and ejection gun in a kitchen.

2. the Prior Arts

Along with the raise of living standard and quality of life, the demand for better quality of environment is getting stronger. In this regard, the water passage elements such as the faucets used in kitchen and wash room are mostly made of copper containing a certain amount of lead, arsenic. Both lead and arsenic are harmful to the health of human body, to cause disease to the user. In order to redress this problem, most of the manufacturers try to make improvements by replacing copper with better materials. Presently, plastic materials such as PE, PEX, etc. are frequently utilized. Since the heat endurance temperature of these plastics is around 60° C., thus it can not withstand long period of usage in high temperature hot water. For this reason, at present, most of the water passage equipment utilizes PERT material.

PERT can be used to make non-cross link polyethylene pipe, to be utilized in hot water, that is also a polyethylene pipe of intermediate density. PERT is characterized to be able to endure high temperature. Besides, it has the advantages of good resilience, press endurance, non-toxic, tasteless, pollution free, and low temperature endurance. As such it is suitable for use as water passage element. Therefore, the replacement of copper with plastic such as PERT as material for water passage element is able to reduce material cost and processing cost significantly, hereby reducing the harm to human body caused by heavy metals contained in copper of the water passage element, and increasing its competitiveness in the market.

In general, the connection of water passage element to other components is achieved mainly through the techniques of rotation welding, integral formation, and thermal plate welding. However, when applying these techniques to PERT, they could cause the following problems:

### With Regard to Rotation Welding

(1) PERT is rather soft, so it tends to deform easily during rotation welding, thus leading to incomplete friction, to form false welding, hereby causing 10% water leakage for the water passage element.

(2) For the positioning welding of water passage elements, since the material of PERT is rather soft, that could cause more than 25% dislocation after welding, thus leading to inaccurate positioning and assembly of the whole set of components and low production yield.

(3) Welding strength is rather unstable.

(4) Length of welding is not easy to control.

### With Regard to Thermal Plate Welding

(1) Since the melting point of PERT is low, it tends to deform significantly during welding, such that after welding, the overflowed welding wax will block the holes in the water passage element, to adversely affect water flowing through the water passage element.

(2) Due to the effect of pre-heating deformation, the welding size and tight seal welding can not be ensured.

### With Regard to Integral Formation

Processing cost is high, and the technology involved is complicated.

To achieve its purpose, it requires to design a water passage element welding method, that is easy to control, and can ensure welding strength stability and tight seal connection.

Therefore, presently, the design and performance of the welding structure for connecting water passage element is not quite satisfactory, and it has much room for improvement.

### SUMMARY OF THE INVENTION

In view of the problems and drawbacks of the prior art, the present invention provides a laser welding structure for connecting a water passage element, that can ensure tight seal connection, to effectively overcome the shortcomings of the prior art.

A major objective of the present invention is to provide a laser welding structure for connecting a water passage element, that is realized through the following embodiment. Wherein, the laser welding structure includes: a water passage soft tube, and a soft tube connector wrapped around one end of the water passage soft tube. The inner surfaces of the soft tube connector and the water passage soft tube are each provided with a deep-color light absorption portion; while the outer perimeter of the soft tube connector is provided with a laser transmission portion. In this structure, the connection portion of the soft tube connector and the water passage soft tube is performed laser fusion, welding, and connection under the irradiation of laser lights.

According to one aspect of the present invention, the transmittance of the laser transmission portion ≧50%.

According to another aspect of the present invention, the color of the deep-color light absorption portion on the inner surface of the soft tube connector is black, or other deep color liable to absorb lights.

According to a further aspect of the present invention, the thickness of the laser transmission portion of the soft tube connector is 1.5˜3.5 mm.

According to another aspect of the present invention, the connection length of the water passage soft tube and a soft tube connector ≧5 mm.

According to yet another aspect of the present invention, the connection of the water passage soft tube and the soft tube connector is of an interference fit, with magnitude of interference on one side from 0.03˜0.08 mm.

According to a further aspect of the present invention, when the water passage element is performed laser welding and fusion, the rotation speed of the water passage element ≦40 mm/s.

Compared with the prior art, the present invention has the advantages that, it solves the problem of inferior welding strength, large deformation, poor tight seal connection, when connecting the plastic water passage element, especially PERT water passage element with water output element through using rotation welding, integral formation, thermal plate welding, thus reducing production cost and raising product quality. In the present invention, a certain pressure is exerted in advance on the connection portion between the water passage soft tube and the soft tube connector, to increase the thermal contact between them during the laser fusion and welding process.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a laser welding structure for connecting a water passage element according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

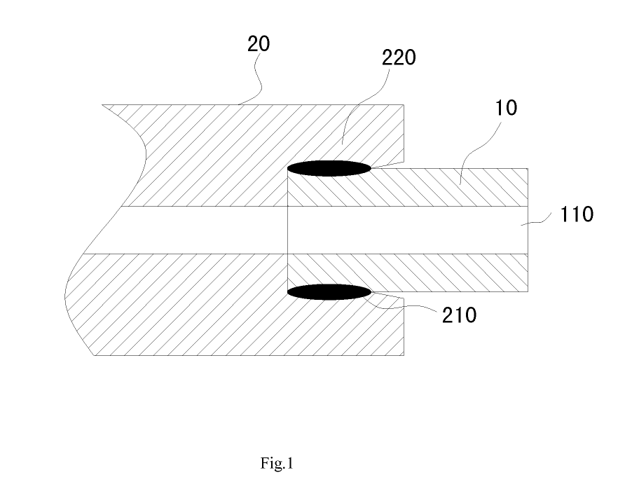

The present invention provides a laser welding structure for connecting a water passage element. Refer to FIG. 1 for a schematic diagram of a laser welding structure for connecting a water passage element according to the present invention

As shown in FIG. 1, the laser welding structure includes: a water passage soft tube 10, and a soft tube connector 20 wrapped around one end of the water passage soft tube 10. Both the water passage soft tube 10 and the soft tube connector 20 are provided with a water passage channel 110 in communication with each other. The inner surfaces of the soft tube connector 20 and the water passage soft tube 10 are each provided with a deep-color light absorption portion 210. The outer perimeter of the soft tube connector 20 is a laser transmission portion 220. In this structure, the connection portion of the soft tube connector 20 and the water passage soft tube 10 is performed laser fusion, welding, and connection under the irradiation of laser lights.

The transmittance of the laser transmission portion 220 ≧50%; while the color of the deep-color light absorption portion 210 on the inner surface of the soft tube connector 20 is black, or other deep color liable to absorb lights.

The thickness of the laser transmission portion 220 of the soft tube connector is preferably 1.5 to 3.5 mm, since a too thick portion 220 would require more laser power for the laser lights to transmit through, while a too thin portion 220 could be deformed due to heat of welding to affect its connection strength. The connection length of the water passage soft tube and the soft tube connector has to be at least greater than 5 mm, to ensure greater pressure endurance strength.

The connection of the water passage soft tube and the soft tube connector is of an interference fit, with magnitude of interference on one side from 0.03 to 0.08 mm, so that the connection portion of the water passage soft tube and the soft tube connector is subject to a certain pressure, to increase significantly the thermal contact between them during the laser fusion and welding process.

In applying welding, firstly, clamp the water passage element on a holder, with a laser device emitting laser light beams perpendicular to the holder, to aim at the welding portion. Then, activate the holder, to rotate the water passage element while performing laser welding. In rotation, the rotation speed of the water passage element is set at ≦40 mm/s, preferably in a range of 20 mm/s˜40% mm/s, to achieve optimized welding effect at the lowest power required.

The parameters utilized in implementing the laser welding structure for connecting a water passage element of the present invention can be summarized in the following table:

table of laser welding parameters

| Seq. | thickness of laser | laser power | holder rotation |
|---|---|---|---|
| no | transmission portion | required | speed |
| 1 | 1.5~2.0 mm | 5 A~10 A | 35~40 mm/s |
| 2 | 2.0~3.0 mm | 10 A~20 A | 30~35 mm/s |
| 3 | 3.0~3.5 mm | 20 A~25 A | 25~30 mm/s |

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A laser welding structure for connecting a water passage element, comprising:
a water passage soft tube; and
a soft tube connector, wrapped around one end of said water passage soft tube,
inner surfaces of said soft tube connector and said water passage soft tube are each provided with a deep-color light absorption portion, outer perimeter of said soft tube connector is a laser transmission portion, such that a connection portion of said soft tube connector and said water passage soft tube is performed laser fusion, welding, and connection under irradiation of laser lights.

2. The laser welding structure for connecting a water passage element as claimed in claim 1, wherein said water passage soft tube and said soft tube connector are made of PERT.

3. The laser welding structure for connecting a water passage element as claimed in claim 1, wherein transmittance of said laser transmission portion ≧50%.

4. The laser welding structure for connecting a water passage element as claimed in claim 1, wherein color of said deep-color light absorption portion on inner surface of said soft tube connector is black, or other deep color liable to absorb lights.

5. The laser welding structure for connecting a water passage element as claimed in claim 1, wherein thickness of said laser transmission portion of said soft tube connector is 1.5˜3.5 mm.

6. The laser welding structure for connecting a water passage element as claimed in claim 1, wherein connection length for said water passage soft tube and said soft tube connector ≧5 mm.

7. The laser welding structure for connecting a water passage element as claimed in claim 1, wherein connection between said water passage soft tube and said soft tube connector is of an interference fit, with magnitude of interference on one side from 0.03˜0.08 mm.

8. The laser welding structure for connecting a water passage element as claimed in claim 1, wherein when said water passage element is performed laser welding, rotation speed of said water passage element is ≦40 mm/s.
